(19) United States
(12) Patent Application Publication
(10) Pub. No.: US 2008/0008590 A1
(43) Pub. Date: Jan. 10, 2008

(54) ELECTRIC FAN WITH BEARING SYSTEM

(75) Inventors: CHIN-WEN YEH, Tu-Cheng (TW); CHIN-LONG KU, Tu-Cheng (TW); HSIEH-KUN LEE, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Tu-Cheng (TW)

(21) Appl. No.: 11/309,176

(22) Filed: Jul. 6, 2006

(51) Int. Cl. F03D 1/00

(52) U.S. Cl. 416/174; 384/127

(57) ABSTRACT

An electric fan includes a fan base (10) having a center tube (11), a bearing assembly received in the center tube and a rotor assembly (20). The bearing assembly includes a plain bearing (40) and a rolling bearing (50). The rotor assembly includes a fan hub (22) and a pivot axle (23) jointed to the fan hub and pivotably extending into the bearing assembly. Lubricant oil is filled between an inner surface of the plain bearing and an outer surface of the pivot axle. A partition element (60) is fixed to the center tube for separating the rolling bearing from the plain bearing, thereby preventing impurities in the lubricant oil from being thrown into the rolling bearing with the lubricant oil.

### FIELD OF THE INVENTION

The present invention relates generally to an electric fan, and more particularly to an electric fan having a bearing system.

### DESCRIPTION OF RELATED ART

Bearing systems are used to pivotably connect two components of devices, such as stators and rotors of fans. Dual ball bearing, sleeve bearing, and a combined bearing having one-ball and one-sleeve bearing are three typical kinds of bearings.

A dual ball bearing comprises an inner ball bearing race for engaging with a central rotary pivot axle of a rotary component of a device and an outer ball bearing race for engaging with a stationary component of the device. A plurality of balls are arranged between the inner and outer ball bearing races. This configuration allows for rotational movement of the inner ball bearing race relative to the outer ball bearing race for rotation of the rotary component without a direct surface movement between the pivot axle and the bearing. A low friction exists between the balls and the inner and outer ball bearing races so that the rotary component can rotate smoothly relative to the stationary component. However, the dual ball bearing has a low load bearing capacity since balls contact with inner and outer ball bearing races in a point-to-point manner. Furthermore, the dual ball bearing has many components, i.e., the inner ball bearing race, the outer ball bearing race and a plurality of balls, which increases the cost thereof.

A sleeve bearing employs a bearing which directly and movably contacts with a rotary pivot axle. A space formed between the bearing and the pivot axle is filled with lubricant oil for reducing friction therebetween. The sleeve bearing has a high load bearing capacity since the bearing contacts with the rotary pivot axle in a surface-to-surface manner and low cost since it employs only a bearing body. However, in working of the sleeve bearing, the lubricant oil is gradually lost which results in high friction being generated between the rotary pivot axle and the bearing and noise being generated accordingly. Furthermore, high friction between the pivot axle and the bearing can reduce the life of the sleeve bearing.

The combined bearing having one-ball and one-sleeve bearing is configured to have the same advantages as the dual ball bearing and the sleeve bearing. However, impurities in the lubricant oil of the sleeve bearing is prone to flow into the one-ball bearing, which leads to an increase of a rolling resistance of the combined bearing. This happens as a result of vibration causing the balls to resonate and abrade on races.

For the foregoing reasons, therefore, there is a need in the art for an electric fan having a bearing system which overcomes the above-mentioned problems.

### SUMMARY OF THE INVENTION

An electric fan in accordance with an embodiment of the present invention includes a fan base having a center tube, a bearing assembly received in the center tube and a rotor assembly. The bearing assembly includes a plain bearing and a rolling bearing. The rotor assembly includes a fan hub and a pivot axle jointed to the fan hub and pivotably extending into the bearing assembly. A space between an inner surface of the plain bearing and an outer surface of the pivot axle is filled with lubricant oil. A partition element is fixed to the center tube for separating the rolling bearing from the plain bearing, thereby preventing impurities in the lubricant oil from flowing into the rolling bearing with the lubricant oil.

Other advantages and novel features of the present invention will become more apparent from the following detailed description of preferred embodiment when taken in conjunction with the accompanying drawings, in which:

### BRIEF DESCRIPTION OF THE DRAWINGS

Many aspects of the present device can be better understood with reference to the following drawings. The components in the drawings are not necessarily drawn to scale, the emphasis instead being placed upon clearly illustrating the principles of the present device. Moreover, in the drawings, like reference numerals designate corresponding parts throughout the several views.

FIG. 1 is an exploded, isometric view of an electric fan in accordance with a preferred embodiment of the present invention;

FIG. 2 is an assembled, cross sectional view of the electric fan of FIG. 1;

FIG. 3 is an enlarged view of a partition element of the electric fan of FIG. 1;

FIG. 4 is a cross-sectional view taken along line III-III of FIG. 3;

FIG. 5 is an assembled, cross sectional view of an electric fan in accordance with an alternative embodiment of the present invention;

FIG. 6 is an enlarged view of a partition element of the electric fan of FIG. 5; and

FIG. 7 is a cross-sectional view taken along line VI-VI of FIG. 6;

### DETAILED DESCRIPTION OF THE INVENTION

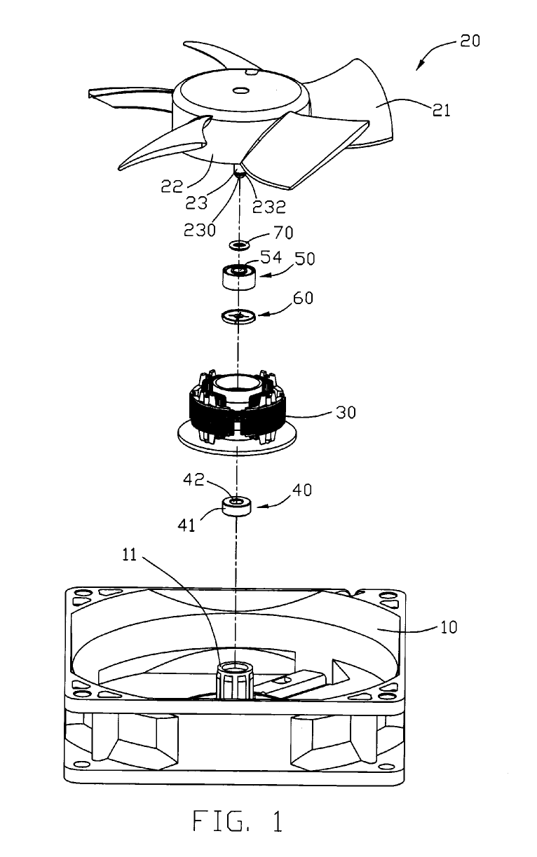

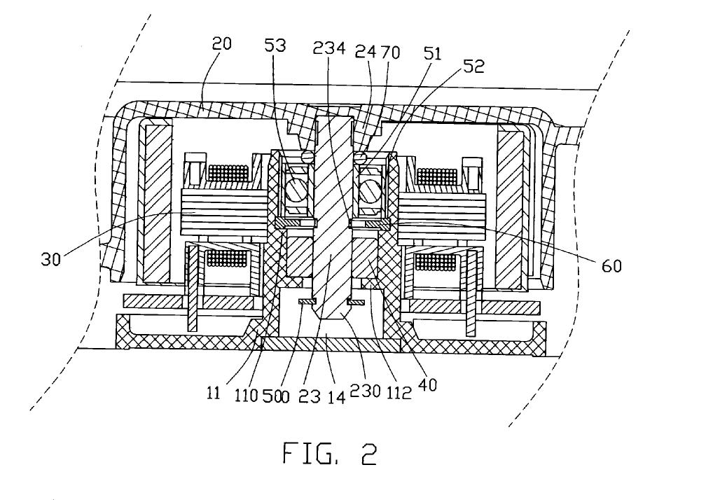

FIGS. 1-2 illustrate by way of example an electric fan in accordance with a preferred embodiment of the present invention. The fan comprises a fan base 10, a rotor assembly 20, a stator assembly 30, a bearing system having a plain bearing 40 (i.e., sleeve bearing) and a rolling bearing 50 (i.e., ball bearing), and a partition element 60 for separating the plain bearing 40 from the rolling bearing 50. The rotor assembly 20 is pivotable with respect to the stator assembly 30.

The fan base 10 defines a cavity therein for receiving the rotor assembly 20 and the stator assembly 30 therein. A center tube 11 is formed at a center portion of the fan base 10. The center tube 11 has a hollow and cylindrical configuration. The bearing system is engagingly received in the center tube 11, wherein the rolling bearing 50 is located in an upper portion of the center tube 11 and the plain bearing 40 is located in a lower portion of the center tube 11. The partition element 60 is transversely disposed between the rolling bearing 50 and the plain bearing 40, for separating the rolling bearing 50 from the plain bearing 40. The stator assembly 30 is attached around the center tube 11. An annular step 110 is formed on an inner wall of the center tube 11 and is located between the rolling bearing 50 and the plain bearing 40, for supporting the partition element 60 thereon. An annular plate 112 extends from an inner wall of the lower portion of the center tube 11 and engages with a bottom of the plain bearing 40, for supporting the plain bearing 40 thereon. A lubricant reservoir 14 is formed in the fan base 10 below the plain bearing 40, for supplying lubricant oil whilst the fan is operating.

The rotor assembly 20 comprises a generally cup-like fan hub 22 having a top wall (not labeled) and a periphery wall (not labeled). A plurality of fan blades 21 are formed around the periphery wall of the fan hub 22. An axle seat 24 is formed on a center of the top wall. A pivot axle 23 extends perpendicularly downwards from the top wall of the fan hub 22 and is surrounded by the axle seat 24. A semispherical-shaped guiding portion 230 is formed at a distal end of the pivot axle 23. An annular slot 232 is defined in the vicinity of the guiding portion 230 for receiving a ring-shaped retainer 500 (shown in FIG. 2) to prevent the rotor assembly 20 from being thrown out of the fan base 10 under a centrifugal force generated by the pivot axle 23 as the fan is operated. Another annular slot 234 is defined in the pivot axle 23 for receiving the partition element 60. The annular slot 234 is located generally corresponding to the annular step 110 formed on the center tube 11.

The plain bearing 40 has a cylindrical shape, and has a circumferential wall 41. A central hole 42 is defined in a central portion of the plain bearing 40 for receiving the pivot axle 23 therein, whereby the pivot axle 23 rotates with respect to the plain bearing 40. The rolling bearing 50 also has a cylindrical shape and defines a central hole 54 therein. The rolling bearing 50 comprises an inner race 51, an outer race 52, a top and bottom walls (not label) connecting an upper and lower ends of the inner and outer races 51, 52, and a plurality of balls 53 freely rotating between both races 51, 52. The pivot axle 23 extends through the central hole 54 and interferingly engages with the inner race 51 of the rolling bearing 50 to rotate with the inner race 51 of the rolling bearing 50. An elastic ring 70 fits around an upper portion of the pivot axle 23 and is located between a top of the inner race 51 and a bottom of the axle seat 24 of the fan hub 22, preventing vibration of the rolling bearing 50 as the fan operates.

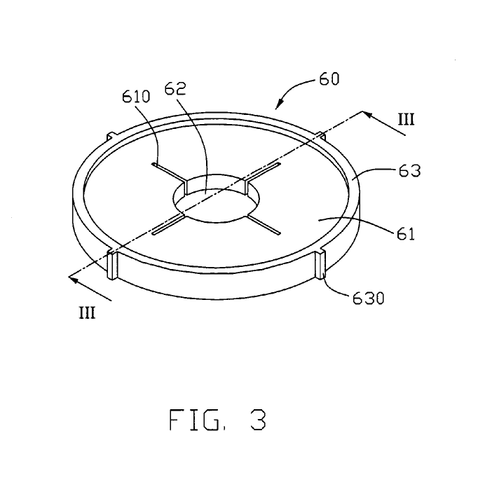

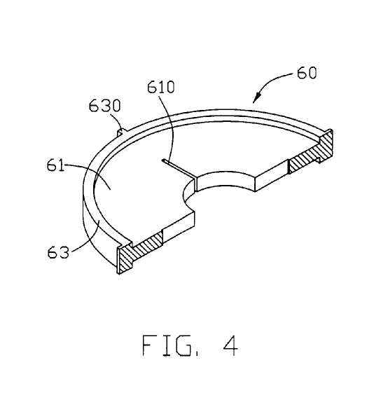

Referring to FIGS. 3-4, the partition element 60 comprises a substantially plate-like body 61 having a central hole 62 defined therein. The partition element 60 is engaged in the annular slot 234 of the pivot axle 23 after the pivot axle 23 extends through the central hole 62, wherein the central hole 62 has a bigger diameter than that of the pivot axle 23 corresponding to the annular slot 234 to prevent a friction between the pivot axle 23 and the partition member 60 as the fan is operated. The body 61 defines four symmetrical elongated slots 610 around and communicating with the central hole 62, for providing elasticity to the body 61 of the partition element 60, whereby the pivot axle 23 can extend through the central hole 62 to reach a position in which an inner edge portion of the body 61 around the central hole 62 extends into the annular slot 234. An annular supporting portion 63 is formed on an outer edge of the body 61 to support the outer race 52 of the rolling bearing 50. The annular supporting portion 63 has a height larger than that of the body 61. Accordingly, the body 61 is separated from the inner race 51 of the rolling bearing 50 (best seen in FIG. 2) so that friction between the inner race 51 and an upper surface of the body 61 is prevented when the electric fan is assembled and operated. Four blocks 630 are symmetrically formed an outer surface of the supporting portion 63 so as to allow their being embedded in corresponding cutouts (not labeled) defined in the center tube 11, thereby preventing rotation of the partition element 60 with the pivot axle 23.

Again referring to FIG. 2, as the fan operates, the pivot axle 23 pivots in the bearing assembly. Under centrifugal force generated by the pivot axle 23, the lubricant oil contained in the lubricant reservoir 14 is drawn upwardly towards a top end of the plain bearing 40 to lubricate the pivot axle 23 and the plain bearing 40. When the lubricant oil is driven upwardly, the lubricant oil flows through at least one gap between the plain bearing 40 and the pivot axle 23 to lubricate both of them. When the lubricant oil reaches the top end of the plain bearing 40 and is blocked by the partition element 60, it flows along the circumferential outer wall of the plain bearing 40 and back to the lubricant reservoir 14. Since the rotor assembly 20 is continuously pivoting, the lubricant oil in the lubricant reservoir 14 is then moved upwardly along the pivot axle 23 by the centrifugal force of the pivot axle 23 to repeat the lubricating process.

In the fan according to the preferred embodiment, the partition element 60 prevents impurities in the lubricant oil from flowing into the rolling bearing 50 with the lubricant oil. The lifetime of the bearing system is thus extended.

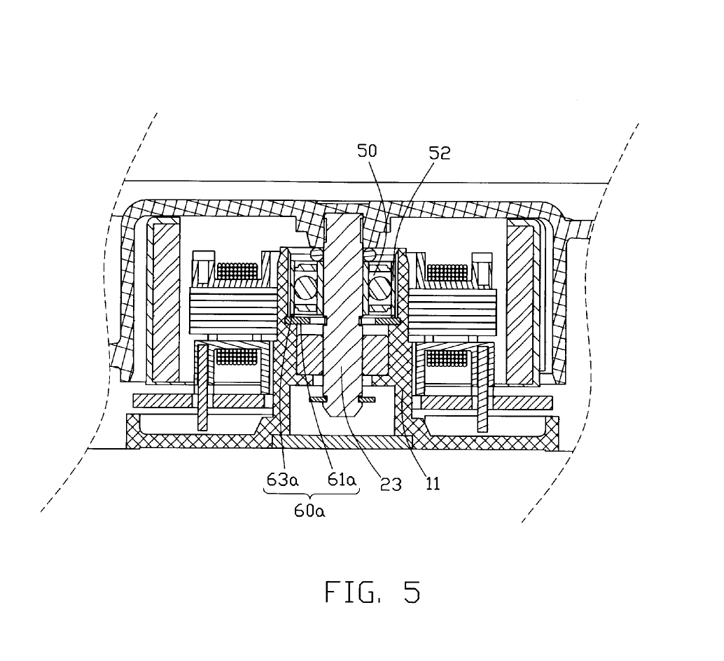

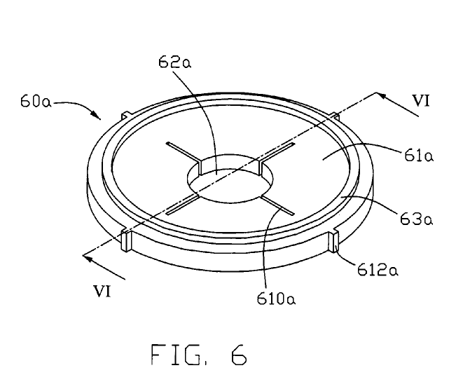

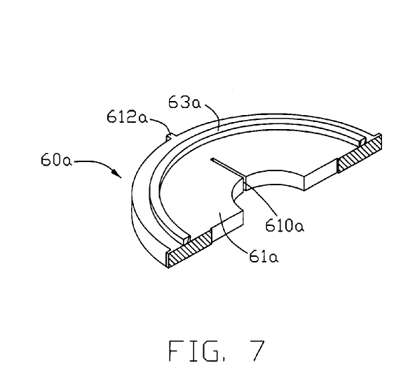

Referring to FIGS. 5-7, a fan of an alternative embodiment is similar to that of the first preferred embodiment. However, a partition element 60a replaces the partition element 60 of the previous preferred embodiment. The partition element 60a comprises a plate-like body 61a and an elastic washer 63a mounted on the body 61a. The body 61a is similar to the body 61 of the first preferred embodiment, and defines a central hole 62a therein and four symmetrical elongated slots 610a around the central hole 62a. Four blocks 612a are symmetrically formed an outer surface of body 61a so as to allow their being embedded in corresponding cutouts (not labeled) defined in the center tube 11, thereby preventing rotation of the partition element 60a with the pivot axle 23. The elastic washer 63a is used for supporting the outer race 52 of the rolling bearing 50 and preventing vibration between the rolling bearing 50 and the partition element 60a. The partition element 60a prevents impurities in the lubricant oil from flowing into the rolling bearing 50 with the lubricant oil. The lifetime of the bearing system is thus extended

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bearing system comprising:
a plain bearing having a hole therein;
a rolling bearing having a hole therein;
a pivot axle extending in the holes of the plain and rolling bearings with a gap being defined between an inner surface of the plain bearing and an outer surface of the pivot axle;
lubricant oil being filled into the gap; and
a partition element being transversely located between the plain bearing and the rolling bearing for separating the plain bearing from the rolling bearing, thereby preventing impurities in the lubricant oil from being thrown into the rolling bearing with the lubricant oil when the pivot axle rotates.

2. The bearing system as claimed in claim 1, wherein the partition element comprises a plate-like body defining a central hole therein, and the pivot axle passes through the central hole.

3. The bearing system as claimed in claim 2, wherein the body defines therein a plurality of slots around and communicating with the central hole, for providing elasticity to the body of the partition element.

4. The bearing system as claimed in claim 2, wherein the rolling bearing comprises an inner race, an outer race and a plurality of balls located between the races, and the pivot interferingly engages with the inner race of the rolling bearing to rotate with the inner race of the rolling bearing.

5. The bearing system as claimed in claim 4, wherein an annular supporting portion is formed on an outer edge of the body for supporting the outer race of the rolling bearing, and the annular supporting portion has a height larger than that of the body, thereby separating the body from the inner race of the rolling bearing.

6. The bearing system as claimed in claim 5, wherein a plurality of blocks is formed on an outer surface of the supporting portion for being engaged in a stationary component receiving the rolling bearing, the partition element and the plain bearing therein, thereby preventing the partition element from rotating with the pivot axle.

7. The bearing system as claimed in claim 4, wherein an elastic washer is mounted on the body for supporting the outer race of the rolling bearing thereon and preventing a vibration between the rolling bearing and the partition element.

8. The bearing system as claimed in claim 7, wherein a plurality of blocks is formed on an outer surface of the body for being engaged in a stationary component receiving the rolling bearing, the partition element and the plain bearing therein, thereby preventing the partition element from rotating with the pivot axle.

9. An electric fan comprising:
a fan base comprising a center tube;
a bearing assembly received in the center tube, the bearing assembly comprising a plain bearing and a rolling bearing;
a rotor assembly comprising a fan hub, and a pivot axle joined to the fan hub and pivotably extending through the bearing assembly, and lubricant oil filled between an inner surface of the plain bearing and an outer surface of the pivot axle; and
a partition element fixed to the center tube, the partition element being configured to separate the rolling bearing from the plain bearing, thereby preventing impurities in the lubricant oil from escaping into the rolling bearing with the lubricant oil when the pivot axle rotates.

10. The bearing system as claimed in claim 9, wherein the partition element comprises a plate-like body defining a central hole therein, and the pivot axle extends through the central hole.

11. The electric fan as claimed in claim 10, wherein the body defines therein a plurality of slots around and communicating with the central hole, for providing elasticity to the body of the partition element.

12. The electric fan as claimed in claim 10, wherein the rolling bearing comprises an inner race, an outer race and a plurality of balls located between both races, and the pivot interferingly engages with the inner race of the rolling bearing to rotate with the inner race of the rolling bearing.

13. The electric fan as claimed in claim 12, wherein an annular supporting portion is formed on an outer edge of the body for supporting the outer race of the rolling bearing, and the annular supporting portion has a height larger than that of the body, thereby separating the body from the inner race of the rolling bearing.

14. The electric fan as claimed in claim 12, wherein an elastic washer mounted on the body for supporting the outer race of the rolling bearing thereon and preventing a vibration between the rolling bearing and the partition element.

15. The electric fan as claimed in claim 12, wherein an axle seat is formed on a center of the top wall, surrounding around the pivot axle.

16. The electric fan as claimed in claim 15, wherein an elastic ring fits around an upper portion of the pivot axle and is located between a top of the inner race and a bottom of the axle seat, for preventing a vibration as the fan operates.

17. An electrical fan comprising:
a base having a central tube;
a stator mounted around the central tube;
a bearing assembly received in the central tube, comprising a plain bearing, a rolling bearing located above the plain bearing and a partition element located between the plain and rolling bearings; and
a rotor having a hub and a pivot axle extending from the hub through the rolling bearing, the partition element and the plain bearing, the partition element functioning to block impurities in lubricant oil in the plain bearing from flowing upwardly into the rolling bearing, the partition element having an inner portion extending into an annular slot defined in a periphery of the pivot axle.

18. The electric fan as claimed in claim 17, wherein the partition element has an outer portion engaging in the central tube.

19. The electric fan as claimed in claim 18, wherein the partition element has a body and an annular supporting portion formed on an outer edge of the body, the annular supporting portion has a height larger than that of the body, the annular supporting portion supporting an outer race of the rolling bearing thereby preventing a contact between an inner race of the rolling bearing and the body of the partition element.

20. The electric fan as claimed in claim 19, wherein the body defines a central hole through which the pivot axle extends and a plurality of slits communicating with the central hole thereby providing elasticity to the body.
